(19) United States
(12) Patent Application Publication
(10) Pub. No.: US 2008/0059480 A1
(43) Pub. Date: Mar. 6, 2008

(54) SYSTEM AND METHOD FOR FILTERING CONTENTS OF A WEB PAGE

(75) Inventors: CHUNG-I LEE, Tu-Cheng (TW); CHIEN-FA YEH, Tu-Cheng (TW); CHIU-HUA LU, Tu-Cheng (TW); XU-CHUN CHEN, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/760,736

(22) Filed: Jun. 9, 2007

(30) Foreign Application Priority Data
Sep. 6, 2006 (CN) 200610200848.4

(51) Int. Cl. G06F 17/30; G06F 15/00

(52) U.S. Cl. 707/10; 707/E17.032

(57) ABSTRACT

A method for filtering contents of a Web page is disclosed. The method includes the steps of downloading and storing the Web page to be selected in the database; converting the Web page from the HTML to the XML; detecting whether the XML Web page contains the elements corresponding to the element selection options; selecting the elements of the XML Web page according to the element selection options; determining whether the content of each of the filtered Web page elements needs to be audited; determining whether the contents of the filtered Web page elements complies with corresponding audited string if the content of each of the filtered Web page elements needs to be audited; storing the filtered Web page in the database if the contents of the filtered Web page elements complies with the audited string. A related system is also disclosed.

### BACKGROUND OF THE INVENTION

1. Field of the Invention

The present invention relates to a system and method for filtering contents of a Web page.

2. General Background

The ever-increasing capabilities of computer networks and the internet has increased a demand for information accessibility. Many Internet users, for example, have a difficultly in focusing on specific information that they are searching for because of the large amount of information that may be compressed into a single screen or Web page and also because of the attempt of Web page designers and marketers to draw the viewers attention to specific information, such as advertisements. Focusing on the important information can be challenging for computer users. Thus, it would be desirable to give the computer user the ability to focus on specific portions of displayed information and to filter other displayed text and graphic information.

What is needed, therefore, is a system for filtering contents of a Web page, which can obtain useful contents of a Web page quickly and efficiently.

Similarly, what is also needed is a method for filtering contents of a Web page, which can obtain useful contents of a Web page quickly and efficiently.

### SUMMARY OF THE INVENTION

A system for filtering contents of a Web page is disclosed. The system includes a database, and an application server connected with the database. The application server includes a downloading module for downloading and storing the Web page in the database; a converting module for converting the Web page from the Hypertext Marked Language format to the Extensible Markup Language format; a determining module for reading element selection options in an XML file, and detecting whether elements of the XML Web page corresponds to the element selection options, for detecting whether content of each of the filtered Web page elements needs to be audited, and for detecting whether content of each of the filtered Web page elements complies with the corresponding audited string; an analyzing module for selecting the elements of the Extensible Markup Language Web page according to the element selection options in the XML file, and filtering the elements that does not comply with the element selection options if the elements of the XML Web page corresponds to the element selection options; and a saving module for storing filtered Web page in the database if the contents of the filtered Web page elements complies with the audited string.

A method for filtering contents of a Web page is disclosed. The method includes the steps of downloading and storing the Web page to be selected in a database; converting the Web page from the Hypertext Marked Language format to the Extensible Markup Language format; reading element selection options in an XML file, and detecting whether the XML Web page contains the elements corresponding to the element selection options; selecting the elements of the Extensible Markup Language Web page according to the element selection options in the XML file, and filtering the elements that does not comply with the element selection options elements if the elements of the XML Web page corresponds to the element selection options; determining whether the content of each of the filtered Web page elements needs to be audited; determining whether the contents of the filtered Web page elements complies with corresponding audited string if the content of each of the filtered Web page elements needs to be audited; and storing the filtered Web page in the database if the contents of the filtered Web page elements complies with the audited string.

Other advantages and novel features of the present invention will become more apparent from the following detailed description of preferred embodiments when taken in conjunction with the accompanying drawings.

### BRIEF DESCRIPTION OF THE DRAWINGS

FIG. 1 is a schematic diagram of hardware configuration of a system for filtering contents of a Web page in accordance with a preferred embodiment;

FIG. 2 is a schematic diagram of main function unit of an application server in FIG. 1; and

FIG. 3 is a flowchart of a preferred method for filtering contents of a Web page in accordance with a preferred embodiment.

### DETAILED DESCRIPTION OF THE INVENTION

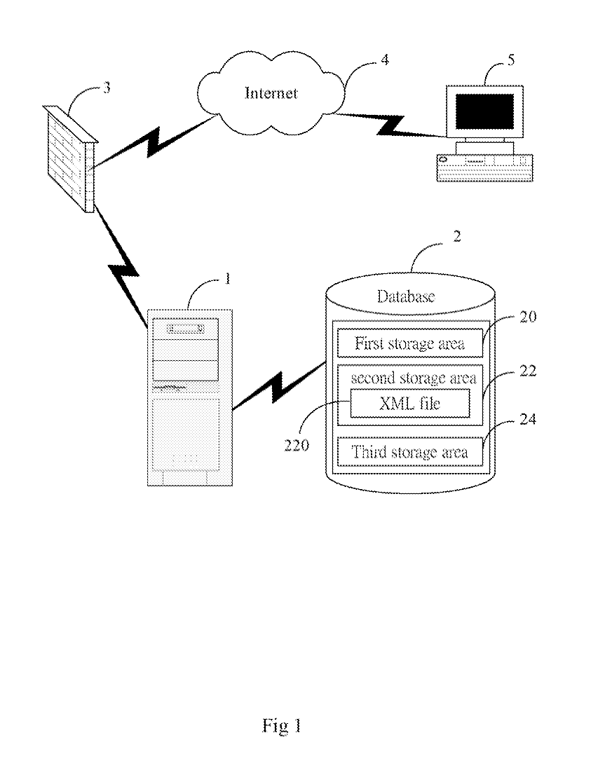

FIG. 1 is a schematic diagram of hardware configuration of a system for filtering contents of a Web page (hereinafter, “the system”) in accordance with a preferred embodiment of the present invention. The system typically includes an application server 1 and a database 2. The application server 1 is used for downloading Web pages via the Web server 5 from the Internet 4 and filtering the contents of downloaded Web pages. The database 2 includes a first storage area 20 for storing the original Hypertext Marked Language formatted (HTML) downloaded Web pages, a second storage area 22 for storing an XML file 220, a third storage area 24 for storing Extensible Markup Language formatted (XML) Web pages and filtered Web pages. The XML file 220 is configured for storing element selection options. A firewall 3 may further be configured between the application server 1 and the Internet 4 for managing Internet security.

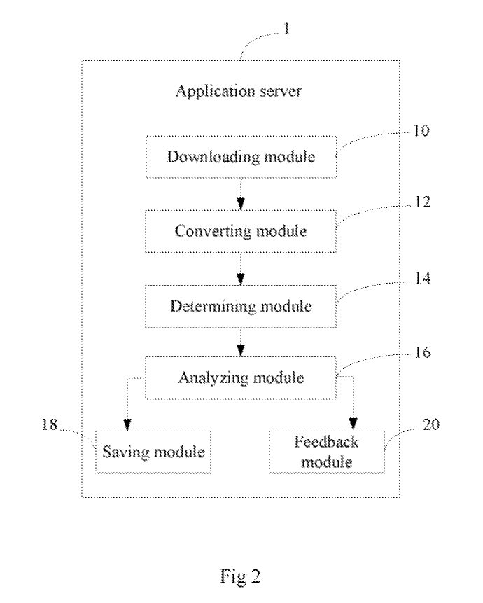

FIG. 2 is a schematic diagram of main function units of the application server 10. The application server 10 typically includes a downloading module 10, a converting module 12, a determining module 14, an analyzing module 16, a saving module 18, and a feedback module 20.

The downloading module 10 is configured for downloading and storing a Web page in the first storage area 20 of the database 2. The Web page is in the Hypertext Marked Language (HTML) format.

The converting module 12 is configured for converting the downloaded Web page from the HTML format to the Extensible Markup Language (XML) format, thereby yielding the XML Web page.

The determining module 14 is configured for reading the element selection options in the XML file 220, and detecting whether the XML Web page contains the elements corresponding to the element selection options. For example, if the element selection options stored in the XML file 220 is:

<option id=“2003”>
<search xpath=“body/div/table[@class=“content”]/**” ></search>
<audit> <keyword> electron </keyword> </audit >
</option>

if the XML Web page contains a <table class=“content”> element, the determining module 14 detects that the XML Web page contains the elements corresponding to the element selection options.

The analyzing module 16 is configured for selecting the elements of the XML Web page according to the element selection options of the XML file 220, and filtering elements that do not comply with the element selection options if the XML Web page contains the elements corresponding to the element selection options, thereby yielding the filtered Web page. For example, if the XML Web page contains:

<body> <div id=“article”>
<table class=“content”>electron </table>
< table >advantages </ table >
</div> </body>

and the XML file 220 contains the element selection option:
<search xpath=“body/div/table[@class=“content”]/**”></search>
the filtered Web page result would be:
<table class=“content”> electron </table>.

The determining module 14 is also configured for detecting whether the content of each filtered Web page elements needs to be audited according to the element selection option. For example, if the element selection option includes an audit string: <audit> <keyword> electron </keyword> </audit>, the determining module 14 detects that the content of the filtered Web page elements needs to be audited. Otherwise, if the element selection option does not include any audit strings, the determining module 14 detects that the content of each of the filtered Web page elements does not need to be audited.

The determining module 14 is further configured for detecting whether the content of each of the filtered Web page elements complies with the audited string if the content of each of the filtered Web page elements needs to be audited. For example, if the filtered Web page is:

<table> electron</table>
and the audited string is:
<audit> <keyword> electron </keyword> </audit>
if the content of the filtered Web page contains the keyword “electron”, the determining module 14 will detect that the content of the filtered Web page complies with the audited string;
if the audited string is:
<audit> <keyword> module </keyword> </audit>
if the content of the filtered Web page element does not contain the keyword “module”, the determining module 14 detects that the content of each of the filtered Web page element does not comply with the audited string.

The saving module 18 is configured for storing the XML Web page in the third storage area 24 of the database 2 if the XML Web page does not contain the elements corresponding to the element selection options in the XML file 220. The saving module 18 is also configured for storing the filtered Web page in the third storage area 24 of the database 2 if the content of each of the filtered Web page elements does not need to be audited. The saving module 18 is further configured for storing the filtered Web page in the third storage area 24 of the database 2 if the content of the filtered Web page elements complies with the audited string.

The feedback module 20 is configured for writing a record of corresponding element selection options in the second storage area 22 of the database 2 if the contents of the filtered Web page elements does not comply with the audited string. For example, a record <option id=“2003” accord=“false”></option> means that the selected option that id=2003 does not comply with the audited string.

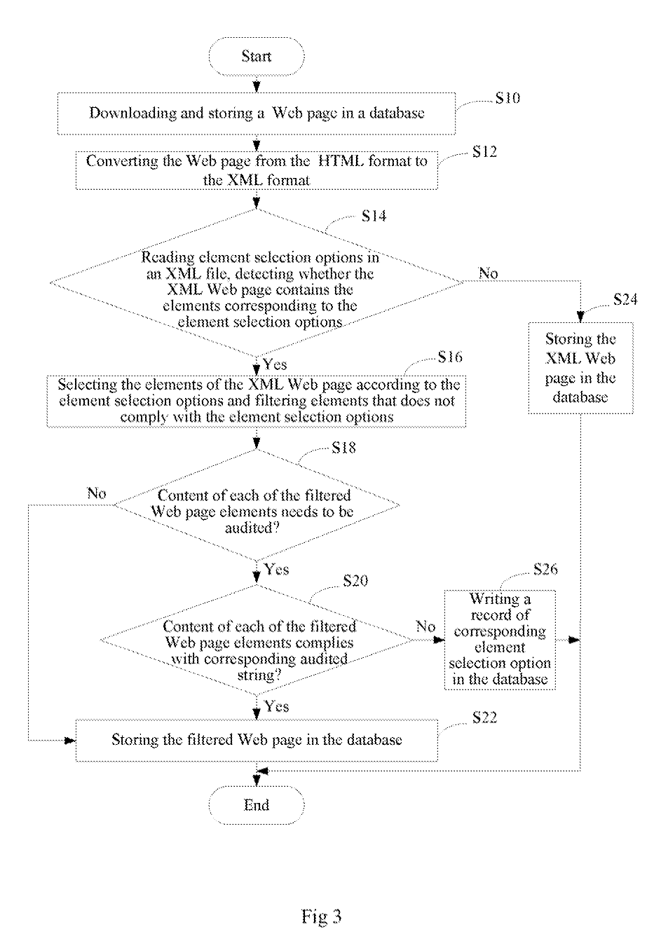

FIG. 3 is a flowchart of a preferred method for filtering contents of a Web page in accordance with a preferred embodiment. In step S10, the downloading module 10 downloads and stores the Web page in the first storage area 20 of the database 2.

In step 12, the converting module 12 converts the Web page from the HTML format to the XML format, thereby yielding the XML Web page.

In step S14, the determining module 14 reads the element selection options in the XML file 220, and detects whether the XML Web page contains the elements according to the element selection options.

If the XML Web page does not contain the elements corresponding to the element selection options in the XML file 220, in step S24, the saving module 18 stores the XML Web page in the third storage area 24 of the database 2 and the procedure ends.

Otherwise, if the XML Web page contains the elements corresponding to the element selection options in the XML file 220, in step S16, the analyzing module 16 selects the elements of the XML Web page according to the element selection options and filters elements of the XML Web page that do not comply with the element selection options.

In step S18, the determining module 14 determines whether the content of each of the filtered Web page elements needs to be audited according to the element selection option.

If the content of each of the filtered Web page elements does not need to be audited, in step S22, the saving module 18 stores the filtered Web page in the third storage area 24 of the database 2 and the procedure ends.

Otherwise, if the content of the filtered Web page elements needs to be audited, in step S20, the determining module 14 detects whether the content of each of the filtered Web page elements complies with the audited string.

If the content of each of the filtered Web page elements does not comply with the corresponding audited string, in step S26, the feedback module 20 writes a record of the element selection options in the second storage area 22 of the database 2 and the procedure ends.

Otherwise, if the contents of each of the filtered Web page elements complies with corresponding audited string, in step S22, the saving module 18 stores the filtered Web page in the third storage area 24 of the database 2.

Although the present invention has been specifically described on the basis of a preferred embodiment and a preferred method, the invention is not to be construed as being limited thereto. Various converts or modifications may be made to said embodiment and method without departing from the scope and spirit of the invention.

What is claimed is:

1. A system for filtering contents of a Web page, the system comprising a database and an application server connected with the database, the application server comprising:
a downloading module for downloading and storing the Web page in the database;
a converting module for converting the Web page from the Hypertext Marked Language format to the Extensible Markup Language format;
a determining module for reading element selection options in an Extensible Markup Language file, and detecting whether elements of the Extensible Markup Language Web page corresponds to the element selection options, for detecting whether content of each of the filtered Web page elements needs to be audited, and for detecting whether content of each of the filtered Web page elements complies with the corresponding audited string;
an analyzing module for selecting the elements of the Extensible Markup Language Web page according to the element selection options in the Extensible Markup Language file, and filtering the elements that does not comply with the element selection options if the elements of the Extensible Markup Language Web page contains the elements corresponding to the element selection options; and
a saving module for storing filtered Web page in the database if the contents of the filtered Web page elements complies with the audited string.

2. The system as claimed in claim 1, wherein the application server further comprises:
a feedback module for writing a record of the corresponding element selection options in the database if the contents of the filtered Web page do not complies with the audit string.

3. The system as claimed in claim 2, wherein the saving module is further configured for storing the Extensible Markup Language Web page directly in the database if the database do not contain any element selection options to select the elements of the Extensible Markup Language Web page, and for storing the filtered Web page directly in the database if the content of each of the filtered Web page elements does not need to be audited.

4. A computer-based method for filtering contents of a Web page, the method comprising the steps of:
downloading and storing the Web page to be selected in a database;
converting the Web page from the Hypertext Marked Language format to the Extensible Markup Language format;
reading element selection options in an Extensible Markup Language file, and detecting whether the Extensible Markup Language Web page contains the elements corresponding to the element selection options;
selecting the elements of the Extensible Markup Language Web page according to the element selection options in the Extensible Markup Language file, and filtering the elements that does not comply with the element selection options elements if the elements of the Extensible Markup Language Web page contains the elements corresponding to the element selection options;
determining whether the content of each of the filtered Web page elements needs to be audited;
determining whether the contents of the filtered Web page elements complies with corresponding audited string if the content of each of the filtered Web page elements needs to be audited; and
storing the filtered Web page in the database if the contents of the filtered Web page elements complies with the audited string.

5. The method as claimed in claim 4, further comprising the step of:
storing the Extensible Markup Language Web page in the database if the Extensible Markup Language Web page does not contain the elements corresponding to the element selection options in the Extensible Markup Language file.

6. The method as claimed in claim 4, further comprising the step of:
storing the filtered Web page in the database if the content of each of filtered Web page elements does not need to be audited.

7. The method as claimed in claim 4, further comprising the step of:
writing a record of the corresponding element selected option in the database if the contents of the filtered Web page elements does not comply with the audited string.

8. A software for filtering contents of a Web page, the software comprising:
a downloading module for downloading and storing the Web page in the database;
a converting module for converting the Web page from the Hypertext Marked Language format to the Extensible Markup Language format;
a determining module for reading element selection options in an Extensible Markup Language file, and detecting whether elements of the Extensible Markup Language Web page corresponds to the element selection options, for detecting whether content of each of the filtered Web page elements needs to be audited, and for detecting whether content of each of the filtered Web page elements complies with the corresponding audited string;
an analyzing module for selecting the elements of the Extensible Markup Language Web page according to the element selection options in the Extensible Markup Language file, and filtering the elements that does not comply with the element selection options if the elements of the Extensible Markup Language Web page contains the elements corresponding to the element selection options; and
a saving module for storing filtered Web page in the database if the contents of the filtered Web page elements complies with the audited string.
